(19) United States
(12) Patent Application Publication
(10) Pub. No.: US 2002/0117172 A1
(43) Pub. Date: Aug. 29, 2002

(54) Floating ball of an underwater breathing apparatus for a diver

(76) Inventor: Chin-Chang Chiang, Chia-I Hsien (TW)

Correspondence Address: Venable, Baetjer, Howard & Civiletti, LLP, Suite 1000, 1201 New York Avenue, N.W., Washington, DC, 20005-3917, US

(21) Appl. No.: 09/793,515

(22) Filed: Feb. 27, 2001

(51) Int. Cl. B63C 11/02; A62B 18/10

(52) U.S. Cl. 128/201.27; 128/201.28

(57) ABSTRACT

A floating ball of an underwater breathing apparatus has a hollow housing, a base, a weighted block and a tube. The base is formed on the bottom of the hollow housing. The weighted block is attached to the bottom of the base or under the base. Multiple through holes are defined in the housing. Multiple vents are defined in the housing and above all of the through holes. The tube extends into the housing to a position near the top of the housing. The tube is connected to a hose connected to a mouthpiece on the other end. Consequently, the center of gravity of the floating ball is lowered and always kept in the bottom of the housing. The floating ball is not easily turned over by waves. In addition, the seawater entering the housing can be automatically drained off through the through holes.

### BACKGROUND OF THE INVENTION

1. Field of the Invention

The present invention relates to a floating ball, and more particularly to a floating ball of an underwater breathing apparatus for a diver.

2. Description of Related Art

An underwater breathing apparatus allows a diver to breathe when he or she is diving. The conventional underwater breathing apparatus substantially comprises a floating ball, a hose and a mouthpiece. The hose is connected to the floating ball. The hose has an opening defined in one end of the hose and extends out from the floating ball. The mouthpiece is attached to the other end of the hose. In use, the diver keeps the mouthpiece in his or her mouth and put the floating ball on the surface of the water, such that the diver can breathe under the water through the hose and the mouthpiece.

However, waves on the surface of the water strike the floating ball. The center of gravity of the floating ball cannot always be kept in the bottom of the floating ball. The wave will turn over the floating ball. The seawater easily enters the hose through the opening, and the diver ingests or inhales water. Danger easily occurs.

To overcome the shortcomings, the present invention tends to provide an improved floating ball of an underwater breathing apparatus to mitigate or obviate the aforementioned problems.

### SUMMARY OF THE INVENTION

The main objective of the invention is to provide an improved floating ball in which the center of gravity is always kept in the bottom of the floating ball or under the floating ball to prevent the floating ball from being turned over. The floating ball has a hollow housing, a base, a weighted block, multiple through holes, multiple vents and a tube. The base is formed on the bottom of the hollow housing and has a top face extending into the housing. The weighted block is attached to the bottom of the base or under the base. Each through hole is defined in the housing near the base. Each vent is defined in the housing above all of the through holes. The tube extends into the housing through the base and to a position near the top of the housing. The tube is connected to a hose connected to a mouthpiece on the other end. By such an arrangement, the center of gravity of the floating ball is lowered and always kept in the bottom of the housing. The floating ball is not easily turned over by waves. In addition, seawater entering the housing can be automatically drained off through the through holes.

Other objects, advantages and novel features of the invention will become more apparent from the following detailed description when taken in conjunction with the accompanying drawings.

### BRIEF DESCRIPTION OF THE DRAWINGS

FIG. 1 is an operational perspective view of an underwater breathing apparatus with a floating ball in accordance with the present invention;

FIG. 2 is a cross sectional side plan view of the floating ball in FIG. 1 with the base having a convex top face and the hose removed;

FIG. 3 is a cross sectional side plan view of the floating ball in FIG. 1 with an air compressor mounted in the base;

FIG. 4 is a cross sectional side plan view of a second embodiment of the floating ball in accordance with the present invention with the base having a concave top face; and

FIG. 5 is a cross sectional side plan view of a third embodiment of the floating ball in accordance with the present invention with the base having a flat top face

### DETAILED DESCRIPTION OF PREFERRED EMBODIMENT

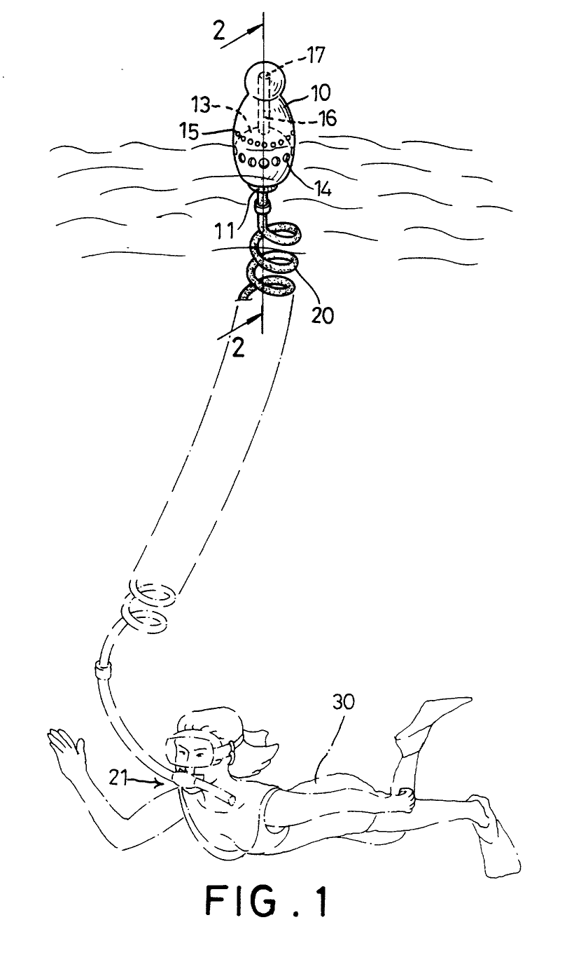

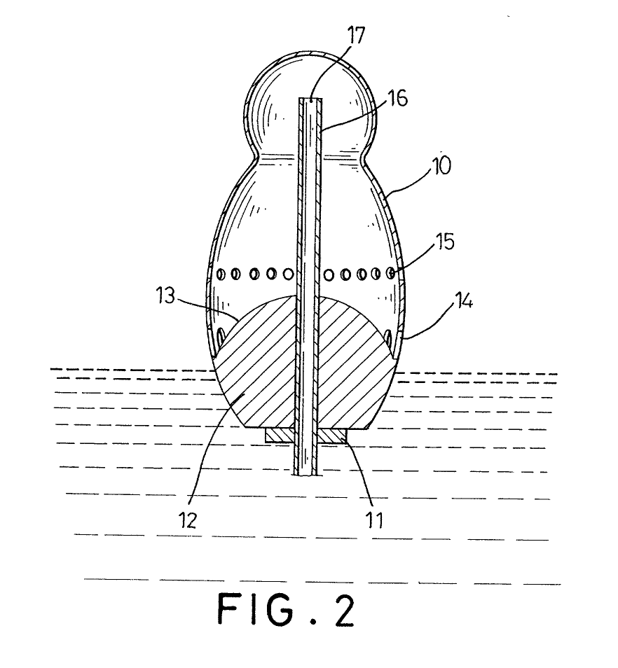

With reference to FIGS. 1 and 2, an underwater breathing apparatus for a diver comprises a floating ball, a hose (20) and a mouthpiece (21). The floating ball floats on the surface of the water. The hose (20) is connected between the floating ball and the mouthpiece (21). The diver (30) keeps the mouthpiece (21) in his or her mouth, such that the diver (30) can breathe underwater through the breathing apparatus.

The floating ball in accordance with the present invention comprises a hollow housing (10), a base (12) and a tube (16). The contour of the housing (10) can be a calabash shape, a cylindrical shape, an ellipsoidal shape, a cubic shape, a spherical shape or an irregular shape. The base (12) is integrally formed on the bottom of the hollow housing (10). The base (12) has a top face (13) extending into the housing (10). The housing (10) and the base (12) are made of a buoyant material like a foam rubber material or the like. A weighted block (11) is attached to the bottom of the base (12) or under the base (12). Consequently, the position of the gravity center of the floating ball is lowered to the bottom of the floating ball. Multiple through holes (14) are defined in the housing (10) near the base (12). Multiple vents (15) are defined in the housing (10) with each above all of the through holes (14).

The tube (16) extends into the housing (10) through the base (12) and to a position near the top of the housing (10). An opening (17) is defined in the top end of the tube (16) and above all of the vents (15). The bottom end of the tube (16) is connected to the hose (20).

With such a floating ball, fresh air can enter the tube (16) through the vents (15) or the though holes (14) in the housing (10) and the opening (17). The diver (30) can breathe underwater, and the diving time is prolonged. Because a weighted block (11) is mounted on the bottom of the base (12), the position of the center of gravity of the floating ball is lowered to the bottom of the floating ball. The floating ball is not easily turned over by waves. The seawater will not enter the tube (16), and the diver will not ingest or inhale water during the period of diving. In addition, because the opening (17) of the tube (16) extends near the top of the housing (10), seawater that enters the ball will be automatically drained off through the through holes (14) and not enter the tube (16).

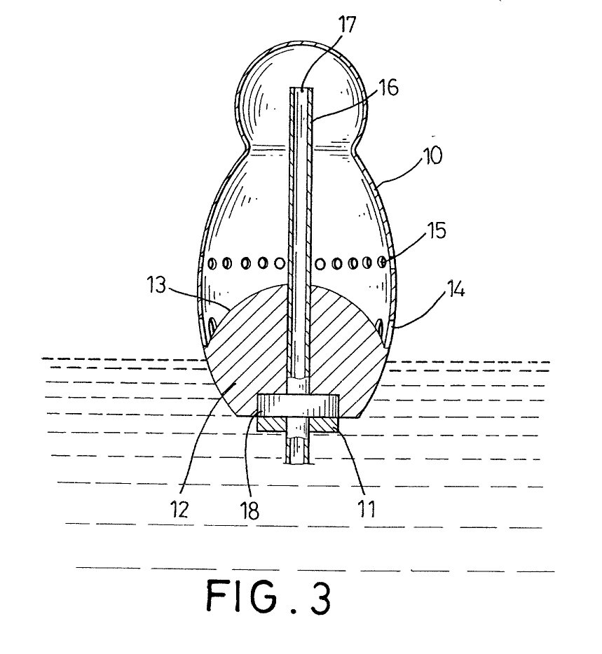

With reference to FIGS. 2 and 3, the top face (13) of the base (12) is a convex surface. The convex top face (13) can lead the seawater out from the housing (10) through the through holes (14). The seawater will not gather in the housing (10).

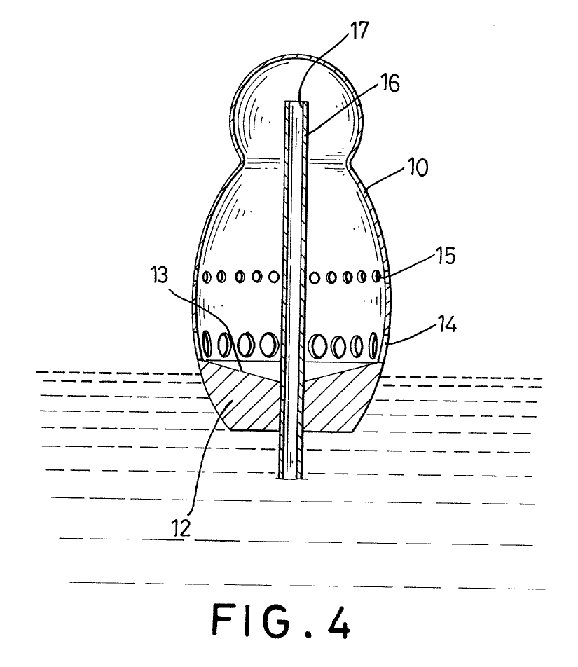

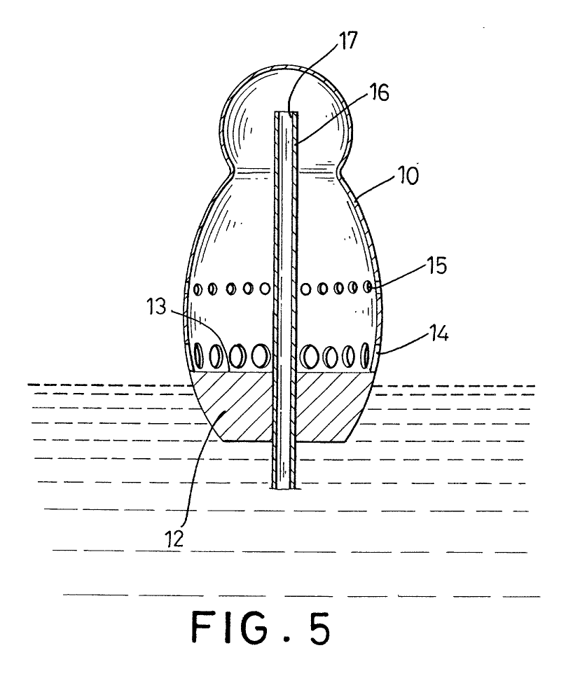

With reference to FIGS. 4 and 5, the base (12) is made of a weighted material, such that the base (12) can replace the weight block (11) shown in FIGS. 2 and 3. The position of the center of gravity of the floating ball is also lowered. The floating ball with a weighted base (12) is not easily turned over, either. With reference to FIG. 4, the top face (13) of the base (12) of another embodiment is a concave surface. Consequently, some of the seawater can be held in the concave top face (13) of the base (12). This adds additional weight to the bottom of the ball. With reference to FIG. 5, the top face (13) of the base (12) of another embodiment is a flat surface. The flat top face (12) can help the seawater inside the ball to be drained off through the through holes (14).

With reference to FIGS. 1 and 3, an air compressor (18) is mounted in the base (12) and communicates with the tube (16). Consequently, fresh air can be forced into the hose (20) by the compressor (18) and provided to the diver (30). This can help the diver (30) breathe when he or she dives deeper under the water.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A floating ball of an underwater breathing apparatus having a hose and a mouthpiece attached to one end of the hose, the floating ball comprising:
a hollow housing;
multiple through holes defined in the housing;
multiple vents defined in the housing and each above all of the through holes;
a tube extending into the housing and having a top end extending to a position near a top of the housing and a bottom end to be adapted to connect to the other end of the hose; and
weights to lower a position of a center of gravity of the floating ball attached to the housing.

2. The floating ball as claimed in claim 1, wherein the weights include a base formed on a bottom of the hollow housing and having a top face extending into the housing; and
a weighted block attached to a bottom of the base;
wherein the housing and the base are made of a buoyant material.

3. The floating ball as claimed in claim 2, wherein the top face of the base is a convex surface.

4. The floating ball as claimed in claim 2 further comprising an air compressor mounted in the base and communicating with the tube to compress the air into the hose through the tube.

5. The floating ball as claimed in claim 1, wherein the weights includes a base formed on a bottom of the hollow housing and having a top face extending into the housing,
wherein the base is made of a weighted material.

6. The floating ball as claimed in claim 5, wherein the top face of the base is a flat surface.

7. The floating ball as claimed in claim 5, wherein the top face of the base is a concave surface.

8. The floating ball as claimed in claim 5 further comprising an air compressor mounted in the base and communicating with the tube to compress the air into the hose through the tube.

9. The floating ball as claimed in claim 1, wherein the housing has a contour with a calabash shape.

10. The floating ball as claimed in claim 1, wherein the housing has a contour with a cylindrical shape.

11. The floating ball as claimed in claim 1, wherein the housing has a contour with an ellipsoidal shape.

12. The floating ball as claimed in claim 1, wherein the housing has a contour with a cubic shape.

13. The floating ball as claimed in claim 1, wherein the housing has a contour with a spherical shape.

14. The floating ball as claimed in claim 1, wherein the housing has a contour with an irregular shape.
